(19) United States
(12) Patent Application Publication
(10) Pub. No.: US 2005/0108076 A1
(43) Pub. Date: May 19, 2005

(54) System for routing and tracking deliverables

(75) Inventors: Curtis Lee Carrender, Morgan Hill, CA (US); Ronald W. Gilbert, Gilroy, CA (US); Jeffrey W. Scott, Pasco, WA (US); David A. Clark, Kennewick, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Battelle Memorial Institute, Richland, WA (US)

(21) Appl. No.: 10/712,983

(22) Filed: Nov. 13, 2003

(51) Int. Cl. G06F 17/60

(52) U.S. Cl. 705/9

(57) ABSTRACT

A system for routing and tracking deliverables, the system including a flexible label having a flexible transponder associated therewith or formed therein for association with a respective deliverable, at least one transceiver configured to communicate with the transceivers to receive control signals; and a routing device coupled to the transceiver and configured to route and sort deliverables in response to control signals received at the transceiver from the transponder.

### STATEMENT REGARDING FEDERALLY SPONSORED RESEARCH OR DEVELOPMENT

This invention was made with U.S. Government support under Contract DE-AC0676RLO1 830 awarded by the U.S. Department of Energy. The U.S. Government has certain rights in the invention.

### BACKGROUND OF THE INVENTION

1. Field of the Invention

The present invention pertains to the shipment of articles, and more particularly to a system and method for delivering articles to a delivery point, including the tracking and routing of the articles from a point of origin to the delivery point.

2. Description of the Related Art

Efficient and timely shipment of mail, packages, and other deliverables is a goal of government and private postal and shipping organizations. Misrouted deliverables is detrimental to not only the sender and the receiver, but to the carrier responsible for delivery to the correct location. Labor and resources expended in locating and rerouting lost packages is costly, both financially and with respect to the carrier's reputation in the marketplace.

Numerous methods have been proposed to improve package delivery. These include color-coded labels, use of postal codes and zip codes, bar codes, electronic scanners, and radio transmitters and receivers.

One example is found in U.S. Pat. No. 6,275,745, which discloses the use of special symbols on the objects inside a package and on the exterior of the package, such as bar codes, to confirm delivery of the object. A battery-powered electronic circuit is attached to the object inside the package and includes a display device and a transmitter to send identifying information about the object to an external receiver. This system requires the use of expensive electronic components that add weight to the material to be shipped. It also requires the use of bar code readers in addition to external transmitters and receivers.

Another example is found in U.S. Pat. No. 5,497,140, which teaches a battery-powered pre-programmed transceiver in the form of a postage stamp or mailing label. The transceiver is formed on a rigid base, which could interfere with processing equipment. In addition, the preprogrammed transceiver requires a linked database in order to use the pre-programmed information.

### BRIEF SUMMARY OF THE INVENTION

The disclosed and claimed embodiments of the invention are directed to a system and method for shipping deliverables, including the tracking and routing thereof. In one embodiment, the system includes a flexible, passive, electromagnetic transponder formed on a flexible substrate and attached to a deliverable, such as an article to be delivered. The transponder is coded at the time of attachment with information regarding one or more of the following: the cost of delivery, identification and address of the sender, identification and address of the receiver, destination information, the delivery route, date of sending, date to be delivered, and identification of the deliverable or the article or contents of the article.

In accordance with another aspect of the invention, the transponder is configured for attachment to a deliverable and configured to transmit control signals regarding routing of the deliverable.

In accordance with a further aspect of the invention, a routing and delivery system is provided that includes a radio-frequency transceiver that communicates with a transponder, such as an RFID tag. Using this communication, the transceiver, such as an RFID interrogator, receives information about an associated deliverable, the routing and delivery thereof, and it sends command and control signals regarding the location and routing of the deliverable.

### BRIEF DESCRIPTION OF THE SEVERAL VIEWS OF THE DRAWING(S)

The foregoing features of the present invention will be more readily appreciated as the same become better understood from the following detailed description when taken in conjunction with the accompanying drawings, wherein:

FIG. 1 is a schematic illustration of a known radio frequency identification system;

FIG. 2 is a schematic illustrating one embodiment of a system for sorting and routing deliverables;

FIG. 3A is an isometric projection of a transponder label formed in accordance with one implementation of the present invention;

FIG. 3B is a schematic representation of the transponder label of FIG. 3A;

FIG. 4 is an illustration of a transponder label and encoding system formed in accordance with the present invention; and

FIG. 5 is a block diagram of a system for encoding, sorting and routing, and tracking deliverables in accordance with another embodiment of the invention.

### DETAILED DESCRIPTION OF THE INVENTION

One form of wireless communication that has become economically and technically feasible in this area is radio frequency identification (RFID).

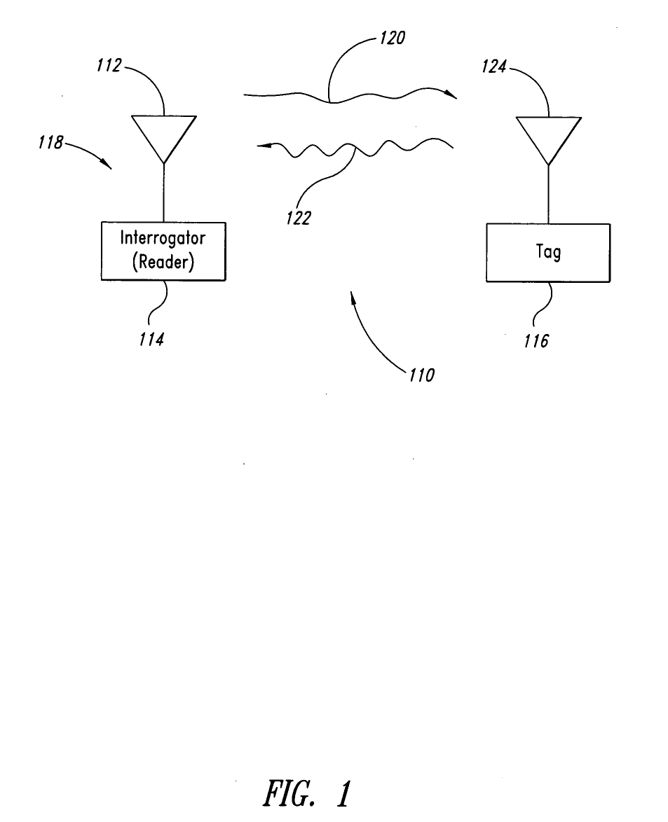

RF identification (RFID) tag systems have been developed to facilitate monitoring of remote objects. As shown in FIG. 1, a basic RFID system 110 consists of three components, an antenna 112 or coil, a transceiver with decoder 114, and a transponder (commonly called an RF tag) 116. In operation, the antenna 112 emits electromagnetic radio signals generated by the transceiver 114 to activate the tag 116. When the tag 116 is activated, data can be read from or written to the tag.

In some applications, the antenna 112 is a component of the transceiver and decoder 114 to become an interrogator (or reader) 118, which can be configured either as a hand held or a fixed-mount device. The interrogator 118 emits the radio signals 120 in range from one inch to one hundred feet or more, depending upon its power output and the radio frequency used. When an RF tag 116 passes through the electromagnetic radio signal waves 120, or the radio signal waves 120 reach the tag 116, the signal 120 is received by the tag 116, thereby activating the tag 116. Data encoded in the tag 116 is then reflected via by a data signal 122 through an antenna 124 to the interrogator 118 for subsequent processing.

An advantage of RFID systems is the non-contact, nonline-of-sight capability of the technology. Tags can be read through a variety of substances such as snow, fog, ice, paint, dirt, and other visually and environmentally challenging conditions where bar codes or other optically-read technologies would be useless. RF tags can also be read at remarkable speeds, in most cases responding in less than one hundred milliseconds.

There are three main categories of RFID tags. These are beam-powered passive tags, battery-powered semi-passive tags, and active tags. Each operate in fundamentally different ways.

The beam-powered RFID tag is often referred to as a passive device because it derives the energy needed for its operation from the radio frequency energy beamed at it. The tag rectifies the field and changes the reflective characteristics of the tag itself, creating a change in reflectivity that is seen at the interrogator. A battery-powered semi-passive RFID tag operates in a similar fashion, modulating its RF cross section in order to reflect a delta to the interrogator to develop a communication link. Here, the battery is the source of the tag's operational power. Finally, in the active RFID tag, a transmitter is used to create its own radio frequency energy powered by the battery.

A typical RF tag system 110 will contain at least one tag 116 and one interrogator 118. The range of communication for such tags varies according to the transmission power of the interrogator 118 and the tag 116. Battery-powered tags operating at 2,450 MHz have traditionally been limited to less than ten meters in range. However, devices with sufficient power can reach up to 200 meters in range, depending on the frequency and environmental characteristics.

Conventional RF tag systems utilize continuous wave backscatter to communicate data from the tag 116 to the interrogator 118. More specifically, the interrogator 118 transmits a continuous-wave radio signal to the tag 116, which modulates the signal 120 using modulated backscattering wherein the electrical characteristics of the antenna 120 are altered by a modulating signal from the tag that reflects a modulated signal 122 back to the interrogator 118. The modulated signal 122 is encoded with information from the tag 116. The interrogator 118 then demodulates the modulated signal 122 and decodes the information.

FIG. 2 shows a simplified implementation of one embodiment of the invention wherein a basic system 10 for identifying, routing or sorting or both, and tracking deliverables is provided. The system 10 includes an identifying and routing label 12, and at least one routing device 14 that responds to information stored in the label and either sorts or routes or sorts and routes for shipping and delivering an associated deliverable (not shown) from a point of origin 16 to a destination or delivery point 18. The routing machines 14,15 have electromagnetic transceivers associated therewith that receive a control signal 20 from the label 12. The control signal 20 includes information about the destination of the deliverable and is used by the routing device 14 to sort the deliverable into the correct delivery path 22 to the point of delivery 18.

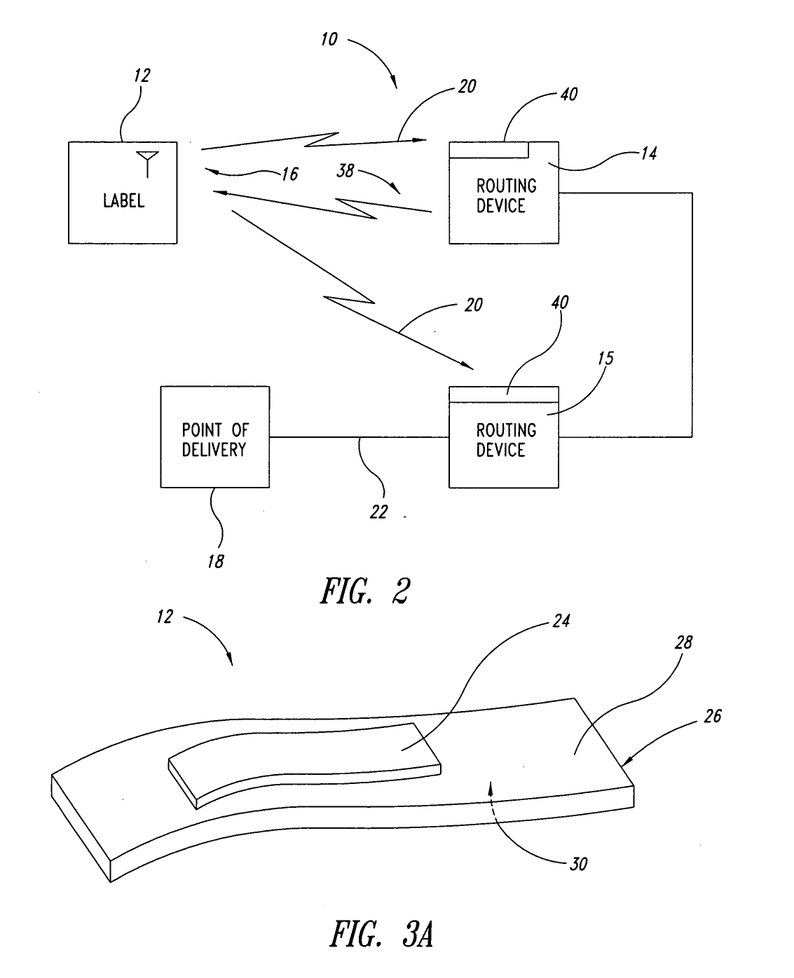

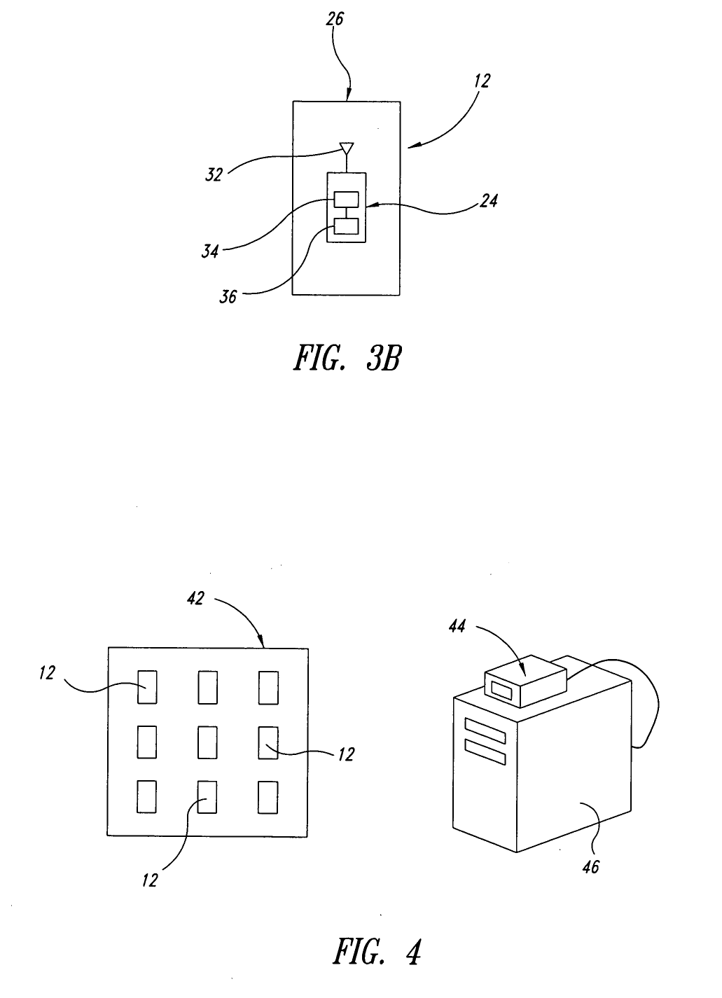

In accordance with one implementation of the invention as shown in FIGS. 3A-3B, the label 12 includes a flexible beam-powered, programmable transponder 24 preferably formed on or integrally with a flexible substrate 26. The flexibility of the substrate 26 and the associated transponder 24 facilitates use of the label on flexible articles, including paper, cloth, plastic, and thin metals. Conventional manufacturing methods and technology may be used in constructing the transponder 24 and the substrates 26. Ideally, the label 12 is formed of material that is disposable and as environmentally friendly as possible.

As shown in FIG. 3A, the transponder 24 is formed in association with a first side 28 of the substrate while a second side 30 is adapted for application to a deliverable. For example, the second side 30 may have self-adhesive formed thereon that enables attachment of the label 12 to an article, a container for an article or articles, or on packaging.

As shown in the schematic of FIG. 3B, the label 12 has the transponder 24 formed thereon to include an antenna 32 coupled to a communication circuit 34 and a memory 36. Ideally, the transponder 24 is formed on a silicon die as an integrated circuit.

The transponder 24 is configured to receive a signal 38 from the electromagnetic transceivers 40, extract energy from the signal 38, and modulate the signal 38 for return back to the transceiver 40. The signal 38 is modulated based upon data stored in the memory 36 or by a predetermined circuit arrangement as known in the art. Preferably the memory 36 in the transponder 24 is programmed by an encoding signal.

Ideally, each label 12 is individually programmed at the time of application to a deliverable with information regarding destination, weight, contents, cost, point of origin, delivery route, shipper, receiver, or any one or combination of the foregoing.

One example of a system for encoding the labels 12 is shown in FIG. 4. Here, the labels 12 are removably adhered to a backing sheet 42 formed of flexible material. Each label 12 can be programmed while attached to the backing sheet 42 or removed from the backing sheet 42 and programmed. Alternatively, two or more of the labels 12 can be simultaneously or consecutively programmed while still attached to the backing sheet 42. An encoder 44 is shown coupled to a processing unit 46, such as a personal computer. The encoder 44 is configured to transmit electromagnetic signals, such as radio-frequency signals, to one or more labels 12 when at a predetermined orientation with respect to the labels 12. For example, a label 12 can be inserted inside the encoder 44 at which time the data is encoded or programmed into the label 12. Data to be encoded onto the label 12 is entered into the processor 46 by conventional means, such as keyboard, mouse, voice, or connection to a local network, or to a worldwide network such as the Internet.

It is envisioned that the labels 12 can be purchased at a postal or shipping agency, at a kiosk, or at a retail location. The labels 12 may be encoded at the time of purchase or at the purchaser's facilities utilizing the encoder 44, such as a private business or subsequently at a residence. Thus, in one scenario, a private consumer can purchase the labels 12 at the post office or retail store, return to their residence and apply the labels 12 to packaging or envelopes after programming them using the address information already stored or to be entered in the processor 46.

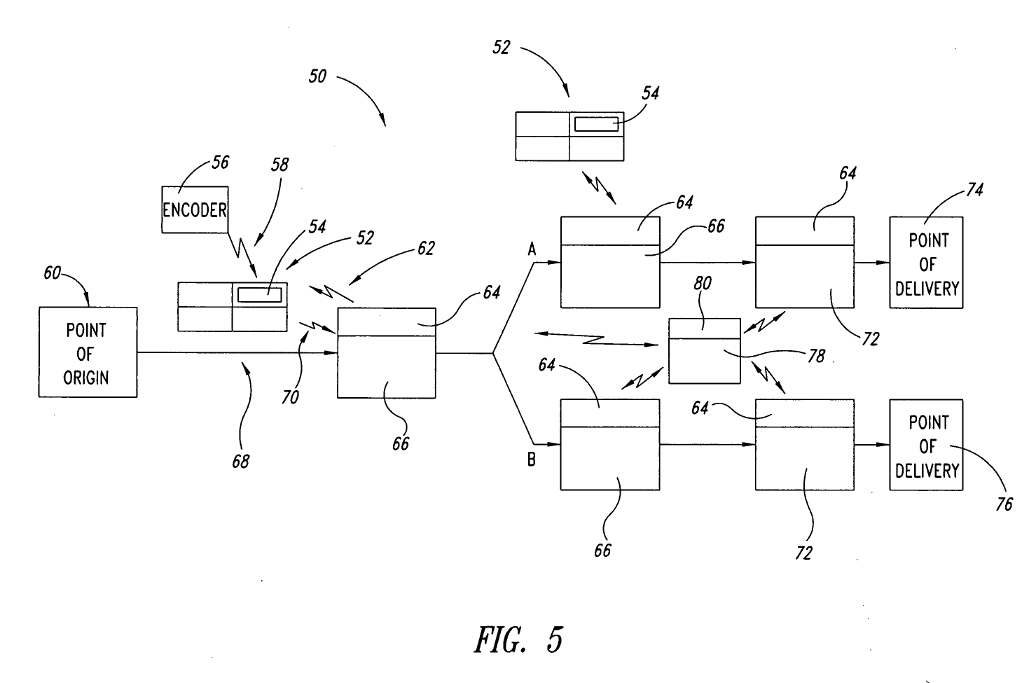

Shown in FIG. 5 is an illustration of another system 50 for routing and tracking deliverables 52. In this example, the deliverable 52 is a package having a routing and tracking label 54 applied thereto that is essentially the same as the label 12 described above in connection with FIGS. 3A-3B. An encoder 56 is configured to program the label 54 via a radio-frequency signal 58. As previously described, encoding can take place at the point of purchase of the label 12 or at the point of origin 60.

Once the label 54 is encoded, either before or after being applied to the deliverable 52, it is configured to respond to signals 62 from a transceiver 64 associated with a routing device 66 in the delivery path 68.

It is to be understood that the label 54 can be applied to an article inside the deliverable 52, to a container holding the article, or to the exterior of the packaging in which the container or articles are shipped. Ideally, all of the communication devices 54, 56 and 64 are configured such that the data stored on the label 54 is retrievable and usable without reference to a linked database. As such, the signal 70 returned by the label 54 in response to the signal 62 from the transceiver 64 can function as a control signal. In a preferred embodiment, the return signal 70 is a backscattered signal reflected by a transponder associated with the label 54. As described above with respect to FIGS. 2 and 3A-3B, the label 54 has a transponder associated therewith that is of low cost, disposable material that is flexible and receives its energy from the signal 62 transmitted by the transceiver 64. In addition, the transponder on the label 54 is programmable to receive information described above with respect to the point of origin, point of destination, shipper, route of delivery, and the like, and to convey this information in the signal 70 to control operation of each of the routing devices 66.

In the system shown in FIG. 5, the first routing device 66 shown immediately after the point of origin 60 selects delivery route A or B in accordance with the control signal 70, and an additional routing device 66 communicates with the label via the transceiver 64 for further routing. A delivery vehicle 72 has its own transceiver 64 for communication with the deliverable 52 and transports the deliverable 52 to the destination or the delivery point 74. The other point of delivery 76 shown at the end of delivery route B is for example only. A tracking center 78 that communicates with each of the routing devices 66 via its own transceiver 80 is used to track the location of the deliverable 52. It is to be understood that communication between the tracking center 78, the routing devices 66, and the delivery vehicle 72 can be by other means, such as the Internet, cable, telephone, and the like.

Although a preferred embodiment of the invention has been illustrated and described, it is to be understood that various changes may be made therein without departing from the spirit and the scope of the invention. For example, although a passive transponder device has been illustrated and described, it is possible to use battery-powered or active transmitters, although such are not preferred because of size, weight, and cost considerations. Furthermore, each transceiver can be configured to communicate with a predetermined group of labels such that deliverables associated with the predetermined group of labels are sorted and routed to a predetermined path while remaining deliverables associated with other labels are sorted and routed to a second delivery path. For example, in FIG. 5, the transceiver 64 can be configured to communicate with only a predetermined group of labels 54 such that deliverables associated with the predetermined group of labels 54 are routed to delivery path A and all other deliverables associated with all other labels are routed to a default path, delivery path B.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A device for use in the delivery of articles, comprising:
a passive electromagnetic transponder formed on a flexible substrate and configured to store and reflect information regarding at least delivery cost and routing information in response to electromagnetic signals.

2. A device for use in the delivery of articles, comprising a passive electromagnetic transponder integrally formed with a flexible label and configured to store information regarding routing of the label to a desired delivery point and to reflect control signals in response to a received signal.

3. A system for use in routing a deliverable, the system comprising a radio-frequency label adapted to be attached to the deliverable and configured to respond to electromagnetic signals to reflect signals regarding the location of the object and control signals for controlling routing of the deliverable.

4. The system of claim 3, further comprising a transceiver configured to transmit the radio frequency signals and to receive the control signals from the label, the control signals comprising information regarding at least the routing of the object.

5. A system for routing a deliverable, the system comprising:
a plurality of routing devices, at least one passive, flexible transponder label configured for attachment to a deliverable, and a plurality of transceivers associated with the routing devices for controlling the sorting and routing of the deliverable in response to electromagnetic signals reflected from the label.

6. The system of claim 5, wherein each of the plurality of transceivers is associated with a predetermined routing device.

7. The system of claim 5, further comprising at least one encoding device configured to code the at least one label with information regarding at least one from among a delivery destination, a delivery date, a delivery route, information regarding a sender, information regarding a receiver, information regarding the deliverable, and information regarding delivery cost.

8. A system for routing and tracking of remote assets, comprising: a plurality of transponders, each transponder associated with a respective asset; at least one transceiver configured to send signals to the transponder and to receive control signals therefrom regarding the associated assets; a routing device to a respective at least one transceiver to receive control and command signals via the transceiver and to sort and route the deliverable; and an encoder configured to transmit programming signals to the at least one transponder.

9. The system of claim 8, wherein each at least one transceiver is integrally formed with the respective routing device.

10. The system of claim 8, wherein each transceiver is configured to communicate with a predetermined group of transponders such that deliverables associated with the predetermined group of transponders are sorted and routed to a predetermined delivery path and all other deliverables are routed to a default path.

11. The system of claim 8, further comprising a tracking device for communicating with the transceivers to track the associated deliverable.

12. A method of routing and tracking deliverables, comprising: providing a plurality of flexible, passive, programmable electromagnetic transponders, each transponder associated with a respective deliverable; issuing signals from a transceiver coupled to a routing device; receiving at the transceiver a control signal from a transponder in response to the signals; controlling the routing device to route the deliverable to a delivery path.

13. The method of claim 12, further comprising an initial step of encoding the transponder with information for use in generating control signals.

14. The method of claim 12, further comprising purchasing at least one transponder and encoding the transponder with a purchase price.

15. The method of claim 12, further comprising communicating via a device for tracking the location of deliverables with each transceiver to track the location of deliverables.
